(19) United States
(12) Patent Application Publication
(10) Pub. No.: US 2025/0109883 A1
(43) Pub. Date: Apr. 3, 2025

(54) PORTABLE AIR CONDITIONER USING AN ARRAY OF PHASE CHANGE MATERIALS

(71) Applicant: Jon Y. Nakagawa, Piedmont, CA (US)

(72) Inventor: Jon Y. Nakagawa, Piedmont, CA (US)

(21) Appl. No.: 18/905,077

(22) Filed: Oct. 2, 2024

Related U.S. Application Data
(60) Provisional application No. 63/542,075, filed on Oct. 2, 2023.

(51) Int. Cl. F24F 13/32; F24F 1/029; F24F 13/20

(52) U.S. Cl. CPC F24F 13/32; F24F 1/029; F24F 13/20; F24F 2221/125

(57) ABSTRACT

A portable air conditioner using an array of phase change materials (PCMs) includes a housing having a detachable top lid. A compressor cools in the housing cools refrigerant and circulates it through a radiator. An array of removable PCMs is mounted between the radiator and fans on the front panel of the housing. Activation of the fans pulls cooled air through the radiator and through the PCMs further cooling the air. The PCMs can be replaced and needed with newly preconditioned PCMs.

### CROSS-REFERENCE TO RELATED APPLICATIONS

This application claims the benefit of Provisional Application No. 63/542,075 filed Oct. 2, 2023.

### BACKGROUND

### Technical Field

The present invention relates generally to air conditioners and more particularly to air conditioners using phase change materials.

### Description of Related Art

Portable air conditioners work by drawing air from the surrounding environment and passing it across evaporator coils which contain refrigerant that absorbs the heat and cools the air. The refrigerant is then pumped through a compressor which changes it from a liquid to a high-pressure gas. The refrigerant releases the absorbed heat through condenser coils. The air cooled by the evaporator coils is blown out of the air conditioner into the surrounding air.

The efficiency of portable air conditioners can be improved by leveraging the ability of phase change materials (PCMs) to absorb and release thermal energy during phase transition. However, heretofore, there has been no practical way to incorporate phase change materials into a portable air conditioner.

### BRIEF DESCRIPTION OF THE DRAWINGS

FIG. 1A is an upper right front perspective view of an air conditioner according to the invention.

FIG. 1B is an upper right rear perspective view thereof.

FIG. 2 is a perspective view thereof similar to FIG. 1 with the front and side panels, lid and wheels removed.

FIG. 3 is perspective view thereof similar to FIG. 2 with the fans and bottom plate removed.

FIG. 4 is an exploded perspective view of FIG. 3.

FIG. 5 is perspective view thereof similar to FIG. 3 with the phase change materials removed.

FIG. 6 is an enlarged perspective view of a support rack for securing the PCMs shown in FIGS. 2-4.

### DETAILED DESCRIPTION OF THE ILLUSTRATED EMBODIMENT

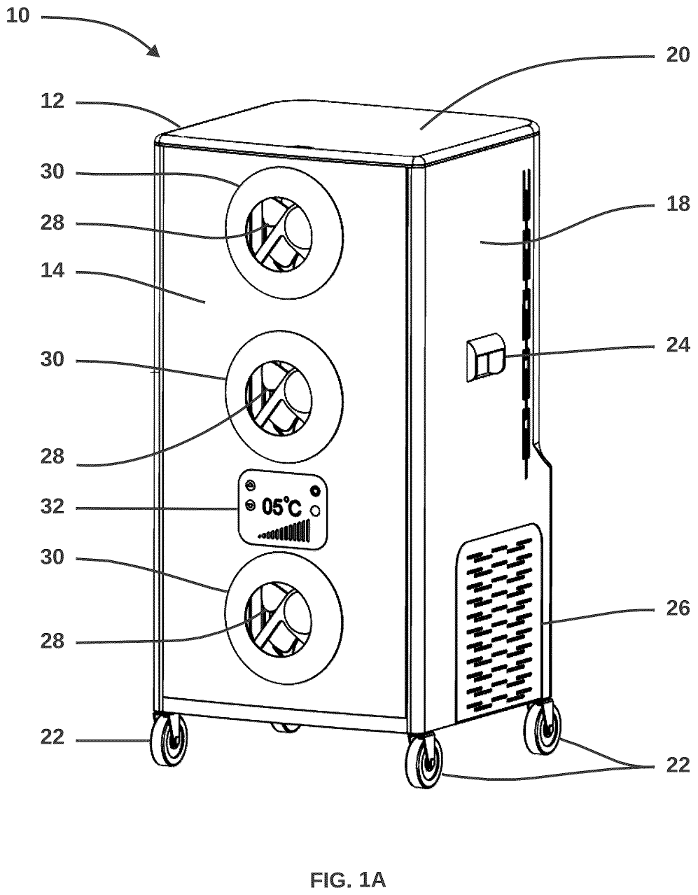

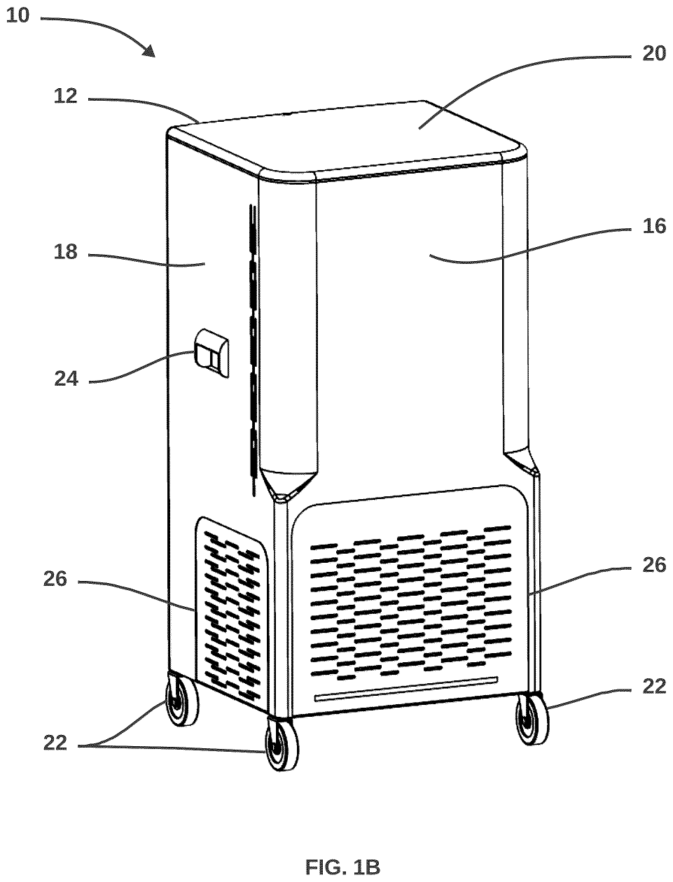

An air conditioner using an array of PCMs according to the invention, depicted generally at 10 in FIGS. 1A, 1B, includes a housing 12 having front 14, rear 16 and side 18 panels, top lid 20 and wheels 22. Each side panel 16 has a handle 24. The rear 16 and side 18 panels may have grill plates 26 for ventilating the housing 12. As seen in FIG. 1A, the front panel 14 includes three fans 28 each of which has a cover plate 30. The front panel 14 may also have a display 32. The top lid 20 is detachable.

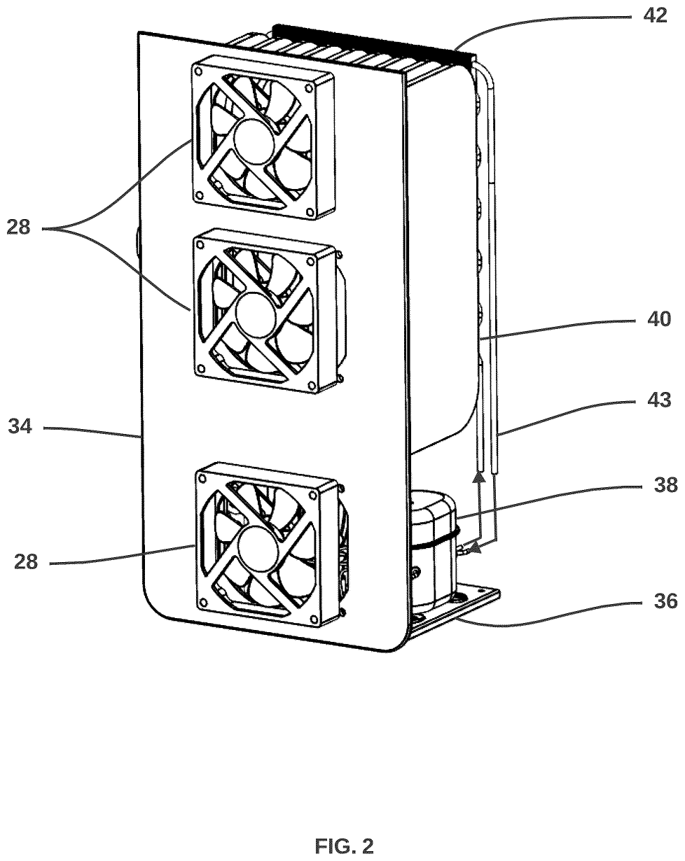

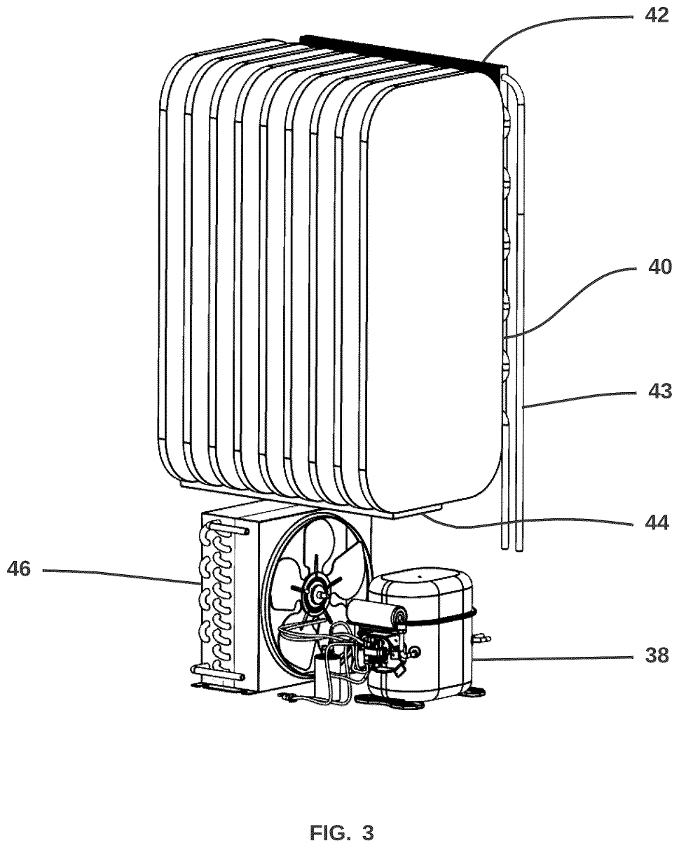

As seen in FIG. 2, removal of the panels 14, 15, 18 and top lid 20 shows that the fans are mounted on a vertical support cover 34 and also reveals a bottom plate 36. A compressor 38 and a cooling radiator 42 are supported on the bottom plate 36. The compressor 38 is fluidly connected to the radiator 42 through tubing 43. A relatively small cooling fan 46 is disposed on the bottom plate for cooling the compressor 38. Phase change materials 40 and a cooling radiator are disposed behind the support cover 34. As seen in FIG. 3, further stripping away the fans 28 and support cover 34 reveals that the PCMs 40 are configured in an array of panels secured on a support rack 44.

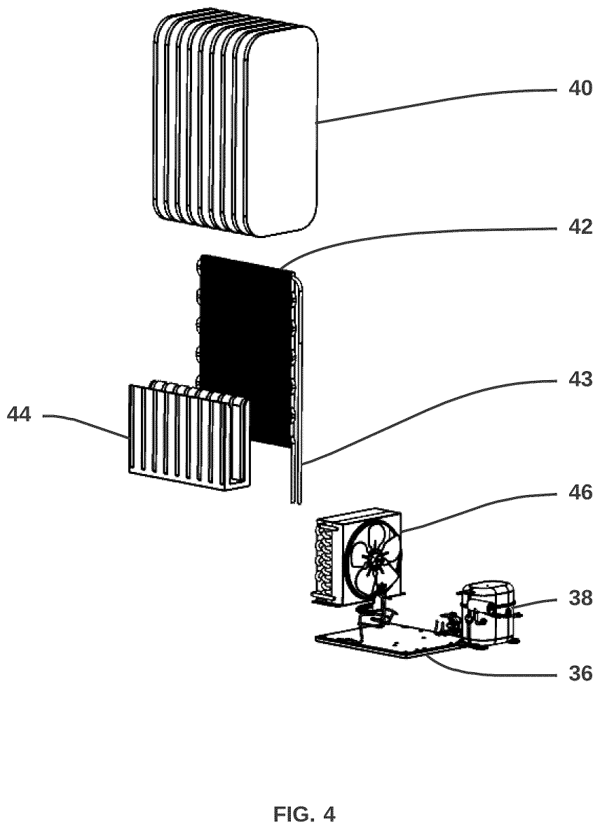

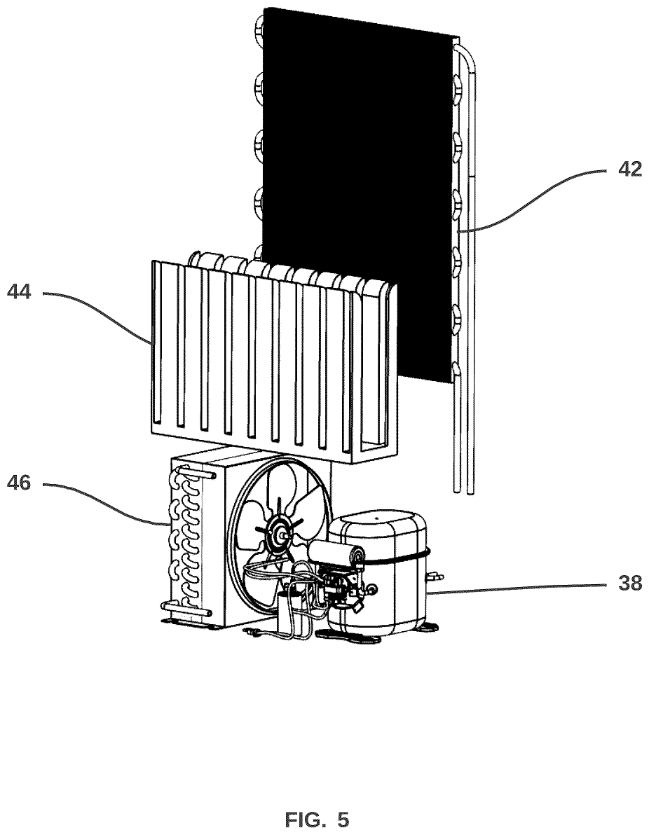

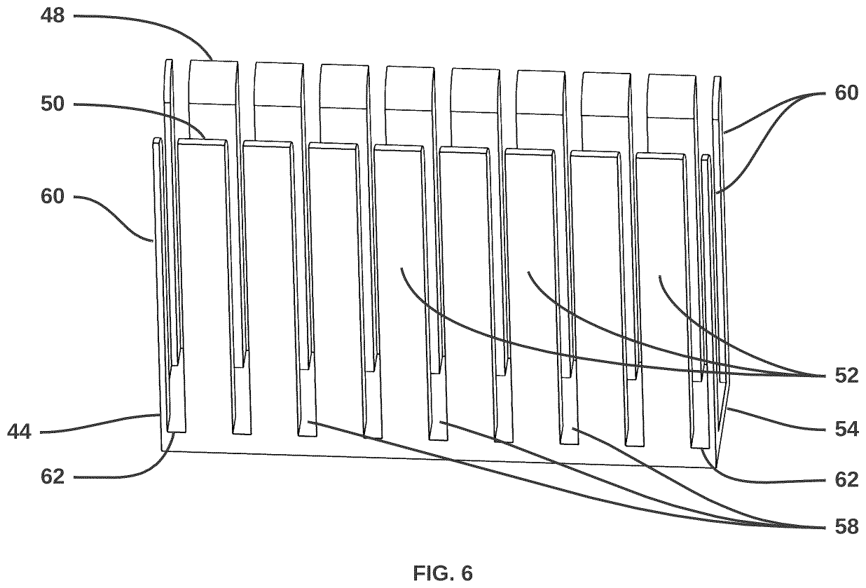

Referring now to FIGS. 4, 5 and 6, it is seen that the support rack 44 includes two spaced apart rows 48, 50 of retention arms 52 supported on a base 54. The retention arms 52 in each row are spaced apart perpendicularly to the rows 48, 50 and define slots 58 between adjoining pairs of retention arms. The rows 48, 50 are arranged so that each slot 58 in each row is disposed across from a cooperating slot in the other row, the cooperating pairs of slots sized to receive one of the plates of the PCMs as seen in FIG. 3. End pieces 60 on each end of rows 48, 50 are similarly spaced from the end-most retention arms 52 to create end slots 62.

Operation of the air conditioner according to the invention is straightforward. Once the device is connected to power, the compressor 38 is activated which circulates refrigerant, such as ammonia, through tubing 43. The dedicated fan 46 cools the compressor 38 while it is in operation. Activation of fans 28 pulls air through the radiator 42. As the cooled air leaves the radiator 42 it passes through the array of PCMs 40 where it is cooled again before exiting the device through cover plates 30. PCMs can be easily replaced in the device as needed by removing the lid 20, removing the used PCMs, and replacing them with preconditioned PCMs.

There have thus been described and illustrated certain embodiments of an air conditioner using an array of PCMs according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

I claim:

1. An air conditioner comprising:
one or more panels, each panel comprising phase change materials, and
a support rack having a base and two or more rows of two or more retention arms mounted on the base, each of the two or more retention arms in each of the two or more rows spaced apart from an adjoining one of the two or more retention arms forming therebetween a panel-receiving slot, at least one slot in each of the two or more rows perpendicularly aligned with a slot in another of the two or more rows forming cooperating pairs of slots, each cooperating pair of slots sized to removably receive one of the one or more panels.

2. The air conditioner of claim 1 wherein said one or more panels comprises two or more panels forming an array, the two or more panels supported in the support rack in spaced apart disposition.

3. The air conditioner of claim 1 further comprising:
a radiator,
a compressor fluidly connected to the radiator for cooling the radiator, and
one or more fans for drawing air through the radiator and across the one or more panels of phase change materials such that cooled air is emitted into the surrounding environment.

4. The air conditioner of claim 3 further comprising:
a housing containing the one or more panels, the support rack, the radiator, the compressor and the one or more fans,
the housing having a removal lid affording access to the interior of the housing so that the one or more panels can be exchanged with preconditioned panels as needed.

5. The air conditioner of claim 4 further comprising:
the housing being mounted on a plurality of wheels to make the air conditioner portable.

6. An air conditioner comprising:
two or more panels, each panel comprising phase change materials,
a support rack having a base and two or more rows of two or more retention arms mounted on the base, each of the two or more retention arms in each of the two or more rows spaced apart from an adjoining one of the two or more retention arms forming therebetween a panel-receiving slot, at least one slot in each of the two or more rows perpendicularly aligned with a slot in another of the two or more rows forming cooperating pairs of slots, each cooperating pair of slots sized to removably receive one of the two or more panels
a radiator,
a compressor fluidly connected to the radiator for cooling the radiator, and
one or more fans for drawing air through the radiator and across the two or more panels of phase change materials such that cooled air is emitted into the surrounding environment.

7. An air conditioner comprising:
a housing containing two or more panels, a support rack, a radiator, a compressor and one or more fans,
each of the two or more panels panel comprising phase change materials,
the support rack having a base and two or more rows of two or more retention arms mounted on the base, each of the two or more retention arms in each of the two or more rows spaced apart from an adjoining one of the two or more retention arms forming therebetween a panel-receiving slot, at least one slot in each of the two or more rows perpendicularly aligned with a slot in another of the two or more rows forming cooperating pairs of slots, each cooperating pair of slots sized to removably receive one of the two or more panels,
the housing having a removal lid affording access to the interior of the housing so that the one or more panels can be exchanged with preconditioned panels as needed, the housing mounted on a plurality of wheels to make the air conditioner portable,
the compressor fluidly connected to the radiator for cooling the radiator, and
one or more fans for drawing air through the radiator and across the two or more panels of phase change materials such that cooled air is emitted into the surrounding environment.
